(19) United States
(12) Patent Application Publication
(10) Pub. No.: US 2023/0348740 A1
(43) Pub. Date: Nov. 2, 2023

(54) INK BASED ON SILVER NANOPARTICLES

(71) Applicant: GENES'INK, Rousset (FR)

(72) Inventors: Corinne VERSINI, Aix-en-Provence (FR); Stéphanie LIMAGE, La Bouilladisse (FR); Alexandre KAUFFMANN, Marseille (FR); Virginie EL QACEMI, Roquevaire (FR); Louis-Dominique KAUFFMANN, Aix-en-Provence (FR)

(21) Appl. No.: 17/757,033

(22) PCT Filed: Nov. 19, 2020
(86) PCT No.: PCT/EP2020/082627

§ 371 Date: Jun. 8, 2022

(30) Foreign Application Priority Data
Dec. 11, 2019 (FR) 1914184

(51) Int. Cl. C09D 11/037; C09D 11/033; C09D 11/14; C09D 11/102; C09D 11/52; H01B 1/22

(52) U.S. Cl. CPC C09D 11/037; C09D 11/033; C09D 11/14; C09D 11/102; C09D 11/52; H01B 1/22

(57) ABSTRACT

The present invention relates to thermoformable and/or stretchable ink formulations based on silver nanoparticles. In particular, the present invention relates to ink formulations based on silver nanoparticles, polyurethane and metal microparticles of silver, copper and/or nickel.

The present invention relates to thermoformable and/or stretchable ink formulations based on silver nanoparticles. In particular, the present invention relates to ink formulations based on silver nanoparticles, polyurethane and metal microparticles of silver, copper and/or nickel, said inks being stable, having improved conductivity, being thermoformable and/or stretchable and making it possible to advantageously form stretchable and/or deformable conductive tracks adapted to deformable connected objects, for example the sensors placed on connected textiles, also referred to as smart textiles, which can be found in numerous fields of application including as non-limiting examples, clothing, health, cleantech, furniture, geotextiles and agriculture.

In numerous industrial fields, there is a real need for the production of conductive tracks adapted to deformable and/or elastic substrates for a wide range of applications such as injection moulding (automotive in particular), deformable connected textiles or objects, sensors and/or biosensors (dressings, cosmetic patches, etc.), RFID and NFC antennas, all these objects therefore being found mainly on moving parts or bodies.

The deformable and/or stretchable inks based on conductive nanoparticles according to the present invention can be printed on all types of substrate, in order to meet the requirements of numerous industrial fields by producing stretchable and/or deformable conductive tracks adapted to said substrates. We may mention for example plastic and thermoplastic materials, silicone compounds, fluorinated compounds, generally any material having an elastic property, polyurethanes, PET, PEN, PC, composite, glass, epoxy, carbon and silicon materials, etc.

The stretchable and/or deformable conductive tracks produced using inks based on conductive nanoparticles according to the present invention can withstand a single or repeated deformation while preserving their physical integrity and their electronic properties, in particular conductivity. Thus, the inks claimed offer numerous advantages, including the following given as non-limiting examples:
improved annealing (homogeneous deposit);
no bubbles/froth generated during printing;
improved dwell time;
greater stability over time than the current inks;
non-toxic solvents and nanoparticles;
intrinsic properties of the nanoparticles preserved; and, in particular,
improved conductivity at annealing temperatures generally between 150° C. and 300° C.
possibility of being printed using numerous printing processes including, for example, screen printing, flexography, ink jet, spray, coating, engraving, etc.; and/or
improved adhesion on plastic substrates (PET, PC) as well as on the other layers generally found in a thermoformed device: decorative, dielectric ink, etc.

Ink

The present invention meets the numerous above-mentioned objectives through the use of a thermoformable and/or stretchable ink adapted to the production of stretchable and/or deformable conductive tracks, said ink comprising:
1. silver nanoparticles in a content of at least 15% by weight, preferably at least 20 by weight of the ink, and, preferably, a content of less than 45% by weight, for example less than 40% by weight of the ink,
2. metal microparticles of silver, copper and/or nickel in a content of at least 15% by weight, preferably at least 20% by weight of the ink, and, preferably, a content of less than 45% by weight, for example less than 40% by weight of the ink,
3. monohydric alcohol of boiling point greater than 150° C. in a content of at least 20 by weight, preferably at least 25% by weight of the ink, and, preferably, a content of less than 50% by weight, for example less than 45% by weight of the ink,
4. a film-forming polymer in a content of at least 0.5% by weight, preferably at least 0.75 by weight of the ink, and, preferably, a content of less than 2% by weight, for example less than 1.25% by weight of the ink,
5. a polyol and/or polyol ether in a content of at least 1.5% by weight, preferably at least
2% by weight of the ink, and, preferably, a content of less than 4% by weight, for example less than 3.5% by weight of the ink, and
6. a cellulose compound in a content of at least 0.4% by weight, preferably at least 0.75 by weight of the ink, and, preferably, a content of less than 2% by weight, for example less than 1.5% by weight of the ink, the sum of the above-mentioned compounds representing at least 90% by weight of the ink, preferably at least 95% by weight of the ink, for example at least 99% by weight of the ink.

Silver Nanoparticles

According to one embodiment of the present invention, the size of the silver nanoparticles of the ink claimed is less than 500 nm, for example between 1 and 250 nm, preferably between 10 and 250 nm, more preferably between 30 and 150 nm.

The distribution of the sizes of the silver nanoparticles as indicated in the present invention can be measured using any suitable method. For example, it can be advantageously measured using the following method: use of a Malvern Nanosizer S type device which has the following characteristics:

Dynamic Light Scattering (DLS) Measurement Method:
Tank type: optical glass
Material: Ag
Refractive index of the nanoparticles: 0.54
Absorption: 0.001
Dispersing agent: Cyclooctane
Temperature: 20° C.
Viscosity: 2.133
Refractive index of the dispersing agent: 1.458
General Options: Mark-Houwink parameters
Analysis Model: General purpose
Equilibration: 120 s
Number of measurements: 4

D50 is the diameter for which 50% of the silver nanoparticles by number are smaller. This value is considered as representative of the average size of the grains.

According to an alternative embodiment of the present invention, the silver nanoparticles are spheroidal and/or spherical. For the present invention and the claims which follow, the term “spheroidal” means that the shape resembles that of a sphere but is not perfectly round (“quasi-spherical”), for example an ellipsoidal shape.

The shape and size of the nanoparticles may be advantageously identified by means of photographs taken by microscope, in particular using a device such as a transmission electron microscope (TEM) in compliance with the indications described below. The measurements are taken using a device such as a transmission electron microscope (TEM) manufactured by Thermofisher Scientific having the following characteristics:
TEM-BF (Bright Field) images are taken at 300 kV,
With a 50 μm objective lens for small magnifications and no objective lens for high resolution,
The dimensional measurements are taken on the TEM images using Digital Micrograph software, and
A mean is calculated on a number of particles representative of the majority of the particles, for example 20 particles, in order to determine a mean area, a mean perimeter and/or a mean diameter of the nanoparticles.

Thus, according to this alternative embodiment of the present invention, the nanoparticles are spheroidal and are preferably characterised using this TEM identification by a mean nanoparticle area of between 300 and 35 000 nm², preferably between 700 and 20 000 nm², and/or by a mean nanoparticle perimeter of between 60 and 650 nm, preferably between 90 and 500 nm, and/or a mean nanoparticle diameter of between 20 and 200 nm, de preferably between 30 et 150 nm.

According to an alternative embodiment of the present invention, the silver nanoparticles have the shape of beads, rods (of length L<200 to 300 nm), cubes, plates or crystals when they do not have a predefined shape.

According to a special embodiment of the present invention, the silver nanoparticles have previously been synthesised by physical or chemical synthesis. Any physical or chemical synthesis can be used in the framework of the present invention. In a special embodiment of the present invention, the silver nanoparticles are obtained by chemical synthesis which uses an organic or inorganic silver salt as silver precursor. As non-limiting examples, we may mention silver acetate, silver nitrate, silver carbonate, silver phosphate, silver trifluorate, silver chloride, silver perchlorate, alone or in a mixture. According to an alternative of the present invention, the precursor is silver nitrate and/or silver acetate.

According to a special embodiment of the present invention, the silver nanoparticles are synthesised by chemical synthesis, by reducing the silver precursor using a reducing agent in the presence of a dispersing agent; this reduction can be carried out with or without a solvent.

Thus, the nanoparticles which are used according to the present invention are characterised by D50 values which are preferably between 1 and 250 nm irrespective of their synthesis method (physical or chemical); they are also preferably characterised by a monodisperse (homogeneous) distribution with no aggregates. D50 values between 30 and 150 nm for spheroidal silver nanoparticles can also be advantageously used.

The silver nanoparticle content as indicated in the present invention can be measured using any suitable method. For example, it can be advantageously measured using the following method:
Thermogravimetric analysis
Device: TGA Q50 manufactured by TA Instrument
Crucible: Alumina
Method: ramp
Measurement range: from ambient temperature to 600° C.
Rate of temperature increase: 10° C./min.

Microparticles

The inks according to the present invention therefore comprise metal microparticles of silver, copper and/or nickel. These microparticles may have the shape of a sphere, a flake, needles/wires/microwires and/or filaments, and have a size of preferably less than 15 μm, for example less than 10 μm, preferably less than 5 μm. Microparticles having (according to the TEM measurement described above) a mean area of between 1 and 25 μm², preferably between 5 and 15 μm², and/or a mean perimeter of between 3 and 20 μm, preferably between 5 and 15 μm, and/or a mean diameter of between 1 and 7 μm, preferably between 1 and 5 μm, may also be advantageously used in the framework of the present invention.

As an example, the metal microparticles may be composed of silver, or a copper-silver mixture, or a nickel-silver mixture. In particular, these microparticles may have a copper core and a silver shell, or a nickel core and a silver shell. For core/shell particles, the metal forming the core will represent for example between 85% and 95% by weight of the total composition of the microparticle.

According to one embodiment of the present invention, the microparticles consist of a mixture of spheroidal, preferably spherical microparticles and microparticles having the shape of flakes.

According to one embodiment of the present invention, the microparticles consist of a mixture of spheroidal, preferably spherical microparticles and microparticles having the shape of filaments, wires, microwires and/or needles.

The content of particles comprising silver as indicated in the present invention can be measured using any suitable method. For example, the same method as that used for the silver nanoparticles will be used.

According to one embodiment of the present invention, the ink claimed comprises these microparticles in a content of at least 15% by weight, preferably at least 20% by weight of the ink, and preferably a content of less than 45% by weight, for example less than 40% by weight of the ink.

Film-Forming Polymer

The inks according to the present invention therefore comprise a film-forming polymer, in particular a synthetic film-forming polymer, selected from polyacrylics, polyvinyls, polyesters, polysiloxanes and/or polyurethanes. The ink comprises in particular an aliphatic polyurethane, for example a functional or non-functional, saturated or unsaturated aliphatic polyurethane, for example a semi-aliphatic polyurethane, functional or non-functional, saturated or unsaturated semi-aliphatic polyurethane. Without wanting to be restricted to this explanation, the applicant considers that this polyurethane, in combination with other compounds of the ink, acts as binder to provide good adhesion and elasticity after deposition.

Monohydric Alcohols of Boiling Point Greater than 150° C.

The inks according to the present invention therefore comprise monohydric alcohol of boiling point greater than 150° C.; for example 2,6-dimethyl-4-heptanol and/or terpene alcohol. The inks according to the present invention preferably comprise a terpene alcohol selected from menthol, nerol, cineol, lavandulol, myrcenol, terpineol (alpha-, beta-, gamma-terpineol, and/or terpinen-4-ol; preferably, alpha-terpineol), isoborneol, citronellol, linalol, borneol, geraniol, and/or a mixture of two or more of said alcohols.

Polyols and/or Polyol Ethers

The inks according to the present invention therefore comprise a polyol and/or a polyol ether. The polyol and/or polyol ether is preferably characterised by a boiling point of less than 260° C. We may mention for example the glycols (for example ethylene glycol, propylene glycol, diethylene glycol, trimethylene glycol, 1,3-butylene glycol, 1,2-butylene glycol, 2,3-butylene glycol, pentamethylene glycol, hexylene glycol, etc.), and/or the glycol ethers (for example the glycol mono- or di-ethers amongst which we may mention for example ethylene glycol propyl ether, ethylene glycol butyl ether, ethylene glycol phenyl ether, propylene glycol phenyl ether, diethylene glycol methyl ether, diethylene glycol ethyl ether, diethylene glycol propyl ether, diethylene glycol butyl ether (butyl carbitol), propylene glycol methyl ether, propylene glycol butyl ether, propylene glycol propyl ether, ethylene glycol dimethyl ether, ethylene glycol diethyl ether, ethylene glycol dibutyl ether, glymes, diethylene glycol diethyl ether, dibutylene glycol diethyl ether, diglymes, ethyl diglyme, butyl diglyme), and/or the glycol ether acetates (for example 2-butoxyethyl acetate, diethylene glycol monoethyl ether acetate, diethylene glycol butyl ether acetate, propylene glycol methyl ether acetate), and/or a mixture of two or more of the above-mentioned compounds.

Cellulose Compounds

The inks according to the present invention therefore comprise a cellulose compound. We may mention for example the alkyl celluloses, the hydroxyalkyl celluloses and the carboxyalkyl celluloses, preferably ethylcellulose.

The ink viscosity measured at a shear rate of 40 s⁻¹ and at 20° C. according to the present invention is generally between 1000 and 100 000 mPa·s, preferably between 3000 and 30 000 mPa·s, for example between 5000 and 20 000 mPa·s.

The viscosity can be measured using any suitable method. For example, it can be advantageously measured using the following method:
Device: Rheometer AR-G2 manufactured by TA Instrument
Conditioning time: Pre-shearing at 100 s⁻¹ for 3 minutes/equilibration for 1 minute
Test type: Shear stages
Stages: 40 s⁻¹, 100 s⁻¹ and 1000 s⁻¹
Stage duration: 5 minutes
Mode: linear
Measurement: every 10 seconds
Temperature: 20° C.
Curve reprocessing method: Newtonian
Reprocessed area: the entire curve

It is therefore clear to those skilled in the art that other embodiments are possible with the present invention, in numerous other specific forms, without leaving the scope of the invention as claimed. Consequently, these embodiments must be considered as examples, which may be modified in the field defined by the scope of the attached claims.

The present invention and its advantages will now be illustrated using the two formulations provided in the tables below; the values given in the tables correspond to concentrations in percentage by weight.

TABLE 1
ink 21-4

| | |
|---|---|
| Spherical nanoparticles of silver with | 30 |
| D50 of 130 nm | |
| Microparticles of silver flakes | 15 |
| Spherical microparticles silver | 15 |
| shell/copper core) with D50 of | |
| 5 microns | |
| Terpineol | 34.4 |
| Ethylcellulose | 1.15 |
| Semi-aliphatic polyurethane | 0.9975 |
| Butyl carbitol | 2.7 |
| Solvent (ethanol/ethylacetate) | 0.7525 |

TABLE 2
ink 21-2

| | |
|---|---|
| Spherical nanoparticles of silver with | 30 |
| D50 of 130 nm | |
| 50/50 mixture of silver microspheres | 30 |
| and microwires | |
| Terpineol | 34.4 |
| Ethylcellulose | 1.15 |
| Semi-aliphatic polyurethane | 0.9975 |
| Butyl carbitol | 2.7 |
| Solvent (ethanol/ethylacetate) | 0.7525 |

TABLE 3
ink 21-11

| | |
|---|---|
| Spherical nanoparticles of silver with | 35 |
| D50 of 130 nm | |
| 50/50 mixture of silver microspheres | 35 |
| and microwires | |
| Terpineol | 23.93 |
| Ethylcellulose | 1.15 |
| Semi-aliphatic polyurethane | 0.89 |
| Butyl carbitol | 3.17 |
| Solvent (ethanol/ethylacetate) | 0.86 |

The inks claimed and thus obtained offer numerous advantages, including the following given as non-limiting examples:
Improved screen printing resolution (line widths<50 μm)
Improved conductivity after thermoforming; and/or
Good adhesion on plastic substrates (PET, PC) as well as on the other layers generally found in a thermoformed device: decorative, dielectric ink, etc.; and/or
Exceptional adhesion on substrates such as glass, ITO (indium tin oxide), PVDF (polyvinylidene fluoride), etc.; and/or
Adhesion preserved after injecting polymer at high temperature on the ink deposit; and/or
Good conductivity after cold elongation, up to 40%.

The present invention and its advantages are also illustrated using the following example which shows the combined effect of the film-forming polymer and the metal microparticles on the properties of the ink after thermoforming.

TABLE 4

| Ink | | % silver | % metal | % other |
|---|---|---|---|---|
| No. | % polyurethane | nanoparticles | microspheres | compounds |
| 303 | 0 | 55 | 0 | 45 |
| 315 | 1 | 55 | 0 | 44 |
| 338 | 1 | 30 | 30 | 39 |

TABLE 5

| | Resistance before | Resistance after | Surface condition |
|---|---|---|---|
| Ink | thermoforming | thermoforming | after |
| No. | (ohm) | (ohm) | thermoforming |
| 303 | 8 | Ø | Crackled |
| 315 | 90 | Ø | Partially crackled |
| 338 | 58 | 47 | Smooth |

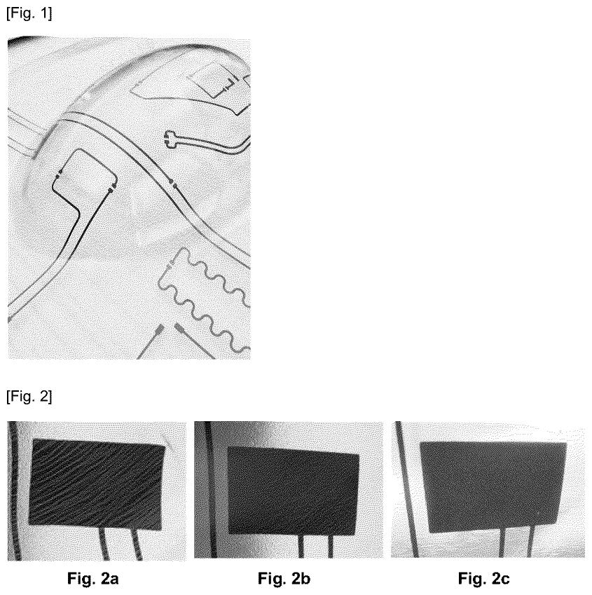

FIG. 1 is graphical representation of the thermoformed ink 338. The comparison between the surface conditions of 303 and 315 illustrates the positive effect of the presence of polyurethane in the ink, changing from a crackled to partially crackled surface condition. Nevertheless, to obtain a smooth surface condition and preserve good electrical properties after thermoforming, the effect of the polyurethane must be combined with that of the microparticles, as demonstrated by the results obtained on ink 338.

FIG. 2 is a graphical representation of the surface condition of the thermoformed inks, respectively from left to right on the figure, inks 303, 315 and 338. The present invention and its advantages are also illustrated using the following example which shows the effect of a mixture of polymorphous particles (wires, spheres of different sizes) on the properties of the ink after stretching:

TABLE 6

| | | % silver | % metal | % poly- | % other |
|---|---|---|---|---|---|
| Ink | % poly- | nano- | micro- | morphous | com- |
| No. | urethane | particles | spheres | particles | pounds |
| 21-1 | 1 | 30 | 30 | 0 | 39 |
| 21-2 | 1 | 30 | 0 | 30 | 39 |
| 21-4 | 1 | 30 | 15 | 15 | 39 |

TABLE 7

| | Resistance | Resistance | Resistance | Resistance | Resistance |
|---|---|---|---|---|---|
| | (ohm) | (ohm) | (ohm) | (ohm) | (ohm) |
| Ink | at 0% | at 10% | at 20% | at 30% | at 40% |
| No. | elongation | elongation | elongation | elongation | elongation |
| 21-1 | 800 | / | / | / | / |
| 21-2 | 11 | 44 | 99 | 195 | 340 |
| 21-4 | 88 | 600 | 1700 | 1500000 | / |

These results show the effect of the presence of polymorphous particles which make the deposit stretchable. The presence of these particles at up to 30% preserves good electrical properties even under 40% stretching.

The following tables show the change in the electrical performance of the ink deposit 21-2 and 21-11 depending on the number of times it has been subjected to 30 elongation for conductive line widths of 2 mm in [Table 8] and line widths of 250 μm for [Table 9]:

TABLE 8

| Number of 30% elongations | R (ohm) ink deposit 21-2 |
|---|---|
| 0 | 11 |
| 10 | 24 |
| 25 | 24 |
| 50 | 35 |

TABLE 9

| Number of | ΔR (ohm)/Initial R | ΔR (ohm)/Initial R |
|---|---|---|
| 30% elongations | (Ohm) ink deposit 21-2 | (Ohm) ink deposit 21-11 |
| 0 | 0 | 0 |
| 10 | 1.6 | 0.4 |
| 20 | 2.5 | 0.6 |
| 30 | 4.0 | 0.6 |
| 40 | 4.8 | 0.8 |
| 50 | 5.5 | 1.0 |

These results indicate satisfactory electrical performance even after fifty 30 elongations. We observe a slight increase in the resistance with the number of elongations.

1. Thermoformable and/or stretchable ink adapted to the production of stretchable and/or deformable conductive tracks, said ink comprising at least 90% by weight of the following compounds:
1. silver nanoparticles in a content of at least 15% by weight of the ink,
2. metal microparticles of silver, copper and/or nickel in a content of at least 15% by weight of the ink,
3. monohydric alcohol of boiling point greater than 150° C. in a content of at least 20% by weight of the ink,
4. film-forming polymer in a content of at least 0.5% by weight of the ink,
5. polyol and/or polyol ether in a content of at least 1.5% by weight of the ink, and
6. a cellulose compound in a content of at least 0.4% by weight of the ink.

2. Ink according to claim 1, characterised in that it comprises:
1. the silver nanoparticles in a content of at least 20% by weight of the ink and less than 45% by weight of the ink,
2. the metal microparticles of silver, copper and/or nickel in a content of at least 20% by weight of the ink and less than 45% by weight of the ink,
3. the monohydric alcohol in a content of at least 25% by weight of the ink and less than 50% by weight of the ink,
4. the film-forming polymer in a content of at least 0.75% by weight of the ink and less than 2% by weight of the ink,
5. the polyol and/or polyol ether in a content of at least 2% by weight of the ink and less than 4% by weight of the ink, and
6. the cellulose compound in a content of at least 0.75% by weight of the ink and less than 2% by weight of the ink.

3. Ink according to claim 1, characterised in that it comprises:
1. the silver nanoparticles in a content of less than 40% by weight of the ink,
2. the metal microparticles of silver, copper and/or nickel in a content of less than 40% by weight of the ink,
3. the monohydric alcohol in a content of less than 45% by weight of the ink,
4. the film-forming polymer in a content of less than 1.25% by weight of the ink,
5. the polyol and/or polyol ether in a content of less than 3.5% by weight of the ink, and
6. the cellulose compound in a content of less than 1.5% by weight of the ink.

4. Ink according to claim 1, characterised in that the silver nanoparticles are spheroidal, for example spherical.

5. Ink according to claim 1, characterised in that the silver nanoparticles have a mean diameter of between 20 and 200 nm, preferably between 30 and 150 nm.

6. Ink according to claim 1, characterised in that the silver nanoparticles have D50 values of between 30 and 150 nm.

7. Ink according to claim 1, characterised in that the microparticles have a mean area of between 1 and 25 μm², preferably between 5 and 15 μm², and/or a mean perimeter of between 3 and 20 μm, preferably between 5 and 15 μm, and/or a mean diameter of between 1 and 7 μm, preferably between 1 and 5 μm.

8. Ink according to claim 1, characterised in that the film-forming polymer is a synthetic polymer selected from polyacrylics, polyvinyls, polyesters, polysiloxanes and/or polyurethanes.

9. Ink according to claim 8, characterised in that the film-forming polymer is an aliphatic polyurethane, for example a semi-aliphatic polyurethane, for example a functional or non-functional, saturated or unsaturated semi-aliphatic polyurethane.

10. Ink according to claim 1, characterised in that the monohydric alcohol of boiling point greater than 150° C. is 2,6-dimethyl-4-heptanol and/or terpene alcohol.

11. Ink according to claim 10, characterised in that the terpene alcohol is terpineol.

12. Ink according to claim 1, characterised in that the polyol and/or polyol ether is selected from glycols and/or glycol ethers.

13. Ink according to claim 1, characterised in that the polyol and/or polyol ether is selected from ethylene glycol, propylene glycol, diethylene glycol, trimethylene glycol, 1,3-butylene glycol, 1,2-butylene glycol, 2,3-butylene glycol, pentamethylene glycol, hexylene glycol, ethylene glycol propyl ether, ethylene glycol butyl ether, ethylene glycol phenyl ether, propylene glycol phenyl ether, diethylene glycol methyl ether, diethylene glycol ethyl ether, diethylene glycol propyl ether, diethylene glycol butyl ether (butyl carbitol), propylene glycol methyl ether, propylene glycol butyl ether, propylene glycol propyl ether, ethylene glycol dimethyl ether, ethylene glycol diethyl ether, ethylene glycol dibutyl ether, glymes, diethylene glycol diethyl ether, dibutylene glycol diethyl ether, diglymes, ethyl diglyme, butyl diglyme.

14. Ink according to claim 1, characterised in that the ink viscosity measured at a shear rate of 40 s⁻¹ and at 20° C. is between 1000 and 100 000 mPa·s, preferably between 3000 and 30 000 mPa·s, for example between 5000 and 20 000 mPa·s.

15. Use of an ink according to claim 1 for its printing/adhesion on glass, ITO (indium tin oxide) or PVDF (polyvinylidene fluoride) substrates.
